(19) United States
(12) Patent Application Publication
(10) Pub. No.: US 2013/0246267 A1
(43) Pub. Date: Sep. 19, 2013

(54) Systems, Methods, and Computer Program Products for Using Proxy Accounts

(71) Applicant: John Patrick Edgar Tobin, San Jose, CA (US)

(72) Inventor: John Patrick Edgar Tobin, San Jose, CA (US)

(73) Assignee: EBAY INC., San Jose, CA (US)

(21) Appl. No.: 13/420,888

(22) Filed: Mar. 15, 2012

(51) Int. Cl. G06Q 20/40

(52) U.S. Cl. 705/44

(57) ABSTRACT

The present disclosure involves a method including creating a primary payment account for an account owner, in which the primary payment account is linked to a method of payment, and creating a proxy payment account, in which the proxy payment account is linked to the primary account but is not linked directly to the method of payment, in which payments to and from the proxy payment account are cleared through the primary account, further in which the primary payment account has first credentials, and in which the proxy payment account has second credentials, the first and second credentials being different.

### BACKGROUND

1. Technical Field

The present disclosure generally relates to electronic transactions, and more particularly, to techniques for using proxy accounts associated with a primary account.

2. Related Art

It is common for consumers and businesses to have electronic accounts to send and receive payments from other parties. One example includes credit cards, which are typically read electronically and transfer money electronically. Another example is a payment service, such as that offered under the name PayPal™, which provides electronic wallets that users can link to credit cards, bank accounts, and any other form of payment.

One problem with most methods of payment, whether electronic or otherwise, is that it can be prone to fraud. For instance, it is not uncommon for criminals to steal credit card information and then to attempt to use the credit card information to pay for goods and services. A typical, modern credit card theft scenario involves a consumer's card that is compromised in some fashion and then canceled and replaced by the card issuer relatively quickly.

While the consumer is not typically obliged to pay for the criminal's purchases, the consumer still feels some inconvenience. For instance, most consumers store credit card information at multiple vendors and may even use a card to make automatic payments toward one or more bills. But when the credit card is suddenly canceled and replaced, the consumer is in the position of having to change the stored information for a variety of vendors and may even miss one or more scheduled payments set up on the old card.

Furthermore, when a user of an account employs the account for making payments to many different entities, it can be quite difficult to determine exactly how an account was compromised because multiple entities have been exposed to the account's credentials. There is currently no convenient solution to protect the integrity of an account while still allowing easy payment.

### SUMMARY

One of the broader forms of the present disclosure involves a method including creating a primary payment account for an account owner, in which the primary payment account is linked to a method of payment, and creating a proxy payment account, in which the proxy payment account is linked to the primary account but is not linked directly to the method of payment, in which payments to and from the proxy payment account are cleared through the primary account, further in which the primary payment account has first credentials, and in which the proxy payment account has second credentials, the first and second credentials being different.

Another one of the broader forms of the present disclosure involves a computer program product having a computer readable medium tangibly recording computer program logic for managing electronic payment, the computer program product including code to generate an electronic user interface for managing electronic payment, code to receive input from a user, via the user interface, indicating a request to create a proxy payment account, code to initiate creation of the proxy payment account in response to the input, the proxy payment account being linked to a primary payment account and to a payment method through the primary payment account, the proxy payment account not being directly linked to the payment method, and code to apply a rule to the proxy payment account, the rule specifying a restriction on use of the proxy payment account.

Another one of the broader forms of the present disclosure involves an electronic device including an input/output interface operable to receive an input from a user and communicate an output to the user, a transceiver operable to electronically communicate with a computer network, a computer processor operable to execute instructions, and a memory storage operable to store the instructions. The memory storage further includes a program module that is operable to: present an electronic Graphical User Interface (GUI) to the user, receive input from the user through the GUI to create a proxy payment account linked to a primary payment account and not directly to a method payment underlying the primary payment account, and receive further input from the user through the GUI to create an operating rule for the proxy payment account.

### BRIEF DESCRIPTION OF THE DRAWINGS

FIG. 1 illustrates an example relationship between a primary payment account and a multitude of proxy payment accounts.

FIGS. 2-7 illustrate an example user interface of an example application program according to various aspects of the present disclosure.

FIGS. 8 and 9 illustrates a flowchart containing example process flows according to various aspects of the present disclosure.

FIG. 10 illustrates a block diagram of a computer system for implementing various methods and devices described according to various aspects of the present disclosure.

FIG. 11 illustrates a block diagram of a computer system for implementing various methods and devices described according to various aspects of the present disclosure.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting.

According to the various aspects of the present disclosure, a method, system, and computer program product are discussed below that improve electronic payment accounts.

In one example, an owner (e.g., a consumer or business) has a primary payment account and many proxy payment accounts that are targeted to individual vendors and have restrictive financial rules amendable by the owner of the primary account. Each proxy account is linked to the primary account, and withdrawals/deposit are from/to the proxy account via the primary account.

One purpose of the proxy accounts is to provide more security about who can withdraw from the account. Thus, in one example, rules are created for each of the proxy accounts specifying payments to/from a single counterparty. In this example, counterparties are payees and payors with respect to the account owner. From another aspect, a purpose of the proxy accounts is to provide greater control of inbound and outbound money. Proxy accounts can be created and destroyed easily by the owner. If primary account information is stolen for a proxy account, when the owner is notified, the owner can quickly cancel and replace the proxy account with a new proxy account. The primary account containing the monies is uncompromised. And in a scenario wherein transactions with the proxy account are limited by rules specifying a maximum transaction size, the primary account may be unharmed, or at worst, harmed within limits set up for the proxy account.

Also, each proxy account can be associated with one or more counterparties, where each counterparty is not exposed to the credentials of the primary account or to other proxy accounts not associated with that counterparty. In such an arrangement, when a counterparty is compromised itself or leaks proxy account information the owner can quickly identify the counterparty responsible. Thus, proxy accounts can not only be used to prevent or limit damage from theft, but proxy accounts can also be used to assist investigations in focusing on a particular instance of compromise. Additionally, when the account owner sets up a system wherein each counterparty is associated with a particular proxy account, tracking payments to/from the counterparty may be simplified, since the payments would be associated with a specific account for that counterparty.

Continuing with the example, an account owner may establish any arbitrary rule or set of rules for a given proxy account. Examples of rules include, e.g., limitations regarding how much a proxy account can distribute in a certain time period, which counterparties are associated with the proxy account, a maximum lifetime for the proxy account, a one-time use lifespan, and the like.

The concept disclosed above encompasses a variety of other uses. For instance, a parent may create a proxy account for a child. The concept can also be extended to credit cards and electronic wallets to provide a security buffer from a primary account and can be extended further to allow proxy account balances.

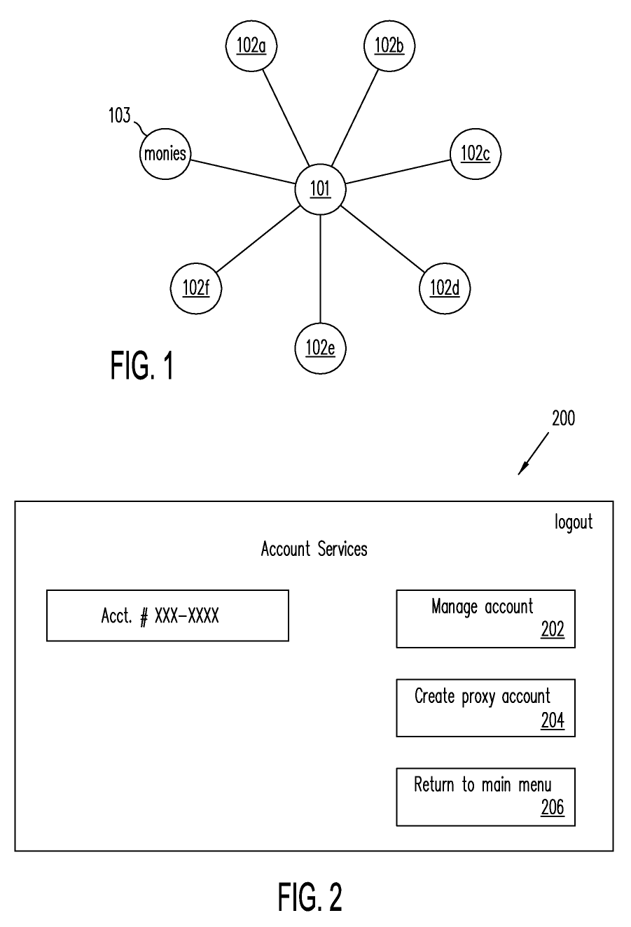

FIG. 1 is an illustration of a primary account and multiple proxy accounts, adapted according to one embodiment. Primary account 101 is linked to the monies 103 and is used to complete all debits and credits in the arrangement of FIG. 1. In an example wherein primary account 101 is a credit card, monies 103 represents the payment facilities of the issuing bank. In an example wherein primary account 101 is an electronic wallet from a payment service, such as PayPal™, monies 103 represent the underlying bank account, credit account, or other facility used to clear the payments to/from primary account 101. However, the scope of embodiments is not limited to credit cards and electronic wallets as primary accounts. Rather, the scope of embodiments may include any appropriate account, such as those accessed by debit cards or the like.

Continuing with FIG. 1, proxy accounts 102a-f are linked to the primary account 101, using primary account 101 as a payment method for deposits and withdrawals. Thus, when a payment is made to proxy account 102a, or proxy account 102a makes a payment, the transaction is cleared through primary account 101, as the source of, and destination for, the money in the transaction. Further, credentials for each of the primary accounts 102 are different from each other and from that of primary account 101.

Proxy accounts 102 are not linked directly to monies 103. Instead, proxy accounts 102 are linked to primary account 101. In one example, wherein primary account 101 is an electronic wallet that provides access to a bank account (as monies 103), payment is made to/from proxy account 102 using primary account 101, and the counterparty may be unaware of the existence of the bank account. In fact, the counterparty may be unaware of the existence of primary account 101 in an example wherein the credentials of primary account 101 are kept from the counterparty.

In another example in which primary account 101 is a credit card, the counterparty is unaware of the primary account's credit card number or of the payment facility of the underlying issuing bank. Also, the proxy account credentials are not valid credentials to access the payment facilities of the issuing bank, as the payments are made through primary account 101.

Thus, the arrangement of FIG. 1 provides at least one degree of separation between proxy accounts 102 and primary account 101, and proxy accounts 102 do not have credentials to directly access monies 103. Thus, the arrangement of FIG. 1 isolates primary account 101 and monies 103 from counterparties, thereby providing an enhanced level of security to the owner of the accounts 101, 102.

In various embodiments an owner creates and manages accounts 101, 102 using a computer to login to a network-based facility. Once the owner is confirmed by the security measures of the payment service, the owner is presented with an interface (e.g., a web-based Graphical User Interface (GUI) or other type of interface) to create and manage accounts.

FIG. 2 illustrates an example user interface 200 for an electronic device adapted according to one embodiment. In the illustrated embodiment, the electronic device may include a smart phone or other hand-held device. In alternative embodiments, the electronic device may be another suitable electronic device such as a computer tablet or laptop/desktop personal computer. The owner may access interface 200 through a web browser, a specialized application, or other appropriate technique. For instance, a user may download application software programs, also known as “apps” or “applications” to the portable electronic device. In general, applications are computer software programs designed to execute specific tasks. As examples, Apple's® App Store, Microsoft's Windows® Store, and Google's® Android Market offer a multitude of applications, including entertainment programs, business applications, file management tools, and other widgets, etc.

Interface 200 is an example of an interface seen by the owner when the owner creates one or more proxy accounts that link to a primary account (as in FIG. 1). Interface 200 may be embodied in any appropriate manner, such as on a touch screen interface or another GUI that uses a mouse or other pointing device. In this example, the various buttons, fields, and some of the text is created using hypertext or other interactive code to allow the user to perform actions with the items on the screen.

FIG. 2 starts off after the owner has already created a primary account, and it is understood that an interface similar to interface 200 could be used to create a primary account as well. The illustration of FIG. 2 begins at an Account Services page that references the primary account, which for purposes of this example is given number XXX-XXXX. The owner is presented with three options, each associated with one of buttons 202, 204, 206. By selecting button 202, the owner can manage the primary account, such as by changing a billing address, password, or the like. Button 206 allows the owner to return to a main menu (not shown).

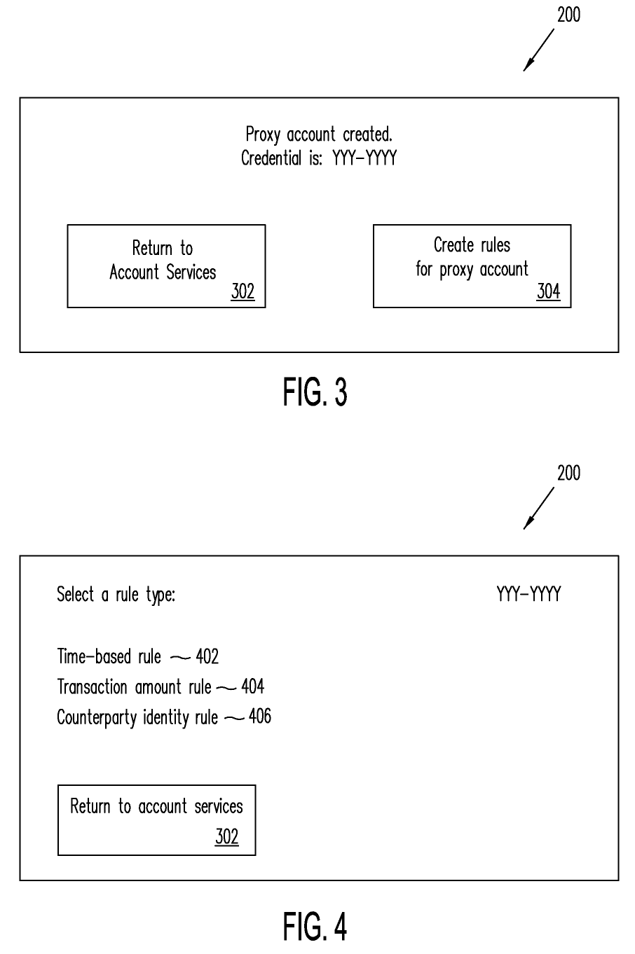

Button 204 triggers the payment service to generate a proxy account that is linked to primary account XXX-XXXX. In some examples, the owner can select credentials for the proxy account (e.g., by generating an account number or login), but in this example, the service generates the credentials. FIG. 3 is an illustration of an example screen in interface 200 showing that the service has created proxy account YYY-YYYY. In FIG. 3, the owner can return to Account Services by selecting button 302. The owner can also create rules for the proxy account by selecting button 304.

Upon selecting button 304, the owner is taken to the screen shown in FIG. 4. The screen of FIG. 4 provides a utility for the owner to create rules to apply to the proxy account. The user can select the text in either options 402, 404, 406 to create a specific rule to apply to the proxy account.

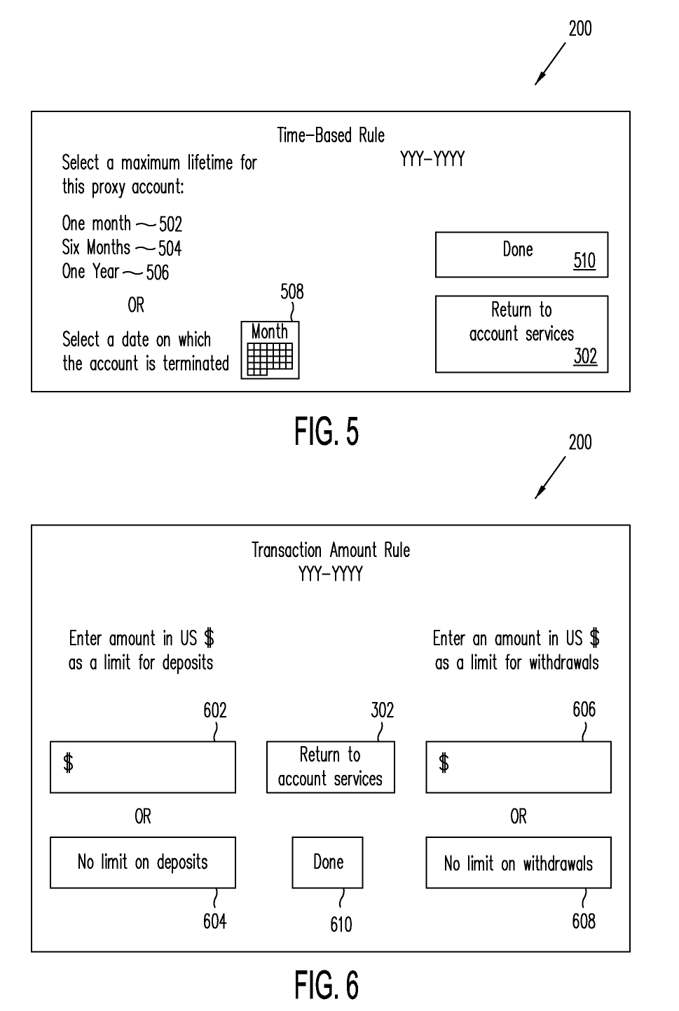

The option shown in text 402 provides for a time-based rule, such as a maximum lifetime for the proxy account. The option shown in text 404 provides for a transaction amount rule (e.g., a maximum amount to transactions to/from the proxy account). Similarly, the option shown in text 406 provides for a counterparty identity rule (e.g., allowing transactions with one or more pre-selected counterparties). Each of these options are described in more detail with respect to FIGS. 5-7.

It should be noted, though, that the options shown in FIG. 4 are illustrative only. The scope of embodiments can include any arbitrary rule for use of a proxy account. Examples of other rules include limiting the proxy account to a single transaction, limiting the proxy account to make payments only during certain pre-defined times, limiting the proxy account to only deposits or only withdrawals, limiting the proxy account for use only with counterparties in certain geographic regions, and the like.

When the owner selects option 402, the service takes the owner to the screen shown in FIG. 5. Within the screen of FIG. 5, the owner can select from pre-defined account lifetimes of one month 502, six months 504, and one year 506. Alternatively, the user can select a specific date from calendar tool 508 on which to deactivate or cancel the proxy account. Once the owner provides a maximum lifetime, the owner may select button 510 to enter the selection.

Although not shown in FIG. 5, other events may be selected that, upon the occurrence of such event, the proxy account is deactivated or canceled. One example is detection of fraud or attempted use outside of the established rule set. Another example includes a pre-defined elapsed time with no activity. Such rules may be default rules or may be selected, and other appropriate events may trigger deactivation or cancellation as well.

Returning to FIG. 4, when the owner selects option 404, the service takes the owner to the screen of FIG. 6 to define transaction amounts for the proxy account. The owner may use field 602 or button 604 to enter, if desired, a transaction amount limit for deposits. Similarly, the owner may use field 606 and button 608 to enter, if desired, a transaction amount for withdrawals. The user may select the done button 610 to enter the selection.

The screen of FIG. 6 is shown as providing an opportunity to enter a per-transaction amount for the proxy account. However, other embodiments may also define a total lifetime amount for transactions using the proxy account. Any appropriate rule to limit an amount of money, whether per-transaction, cumulative over a span of time, or otherwise are within the scope of embodiments.

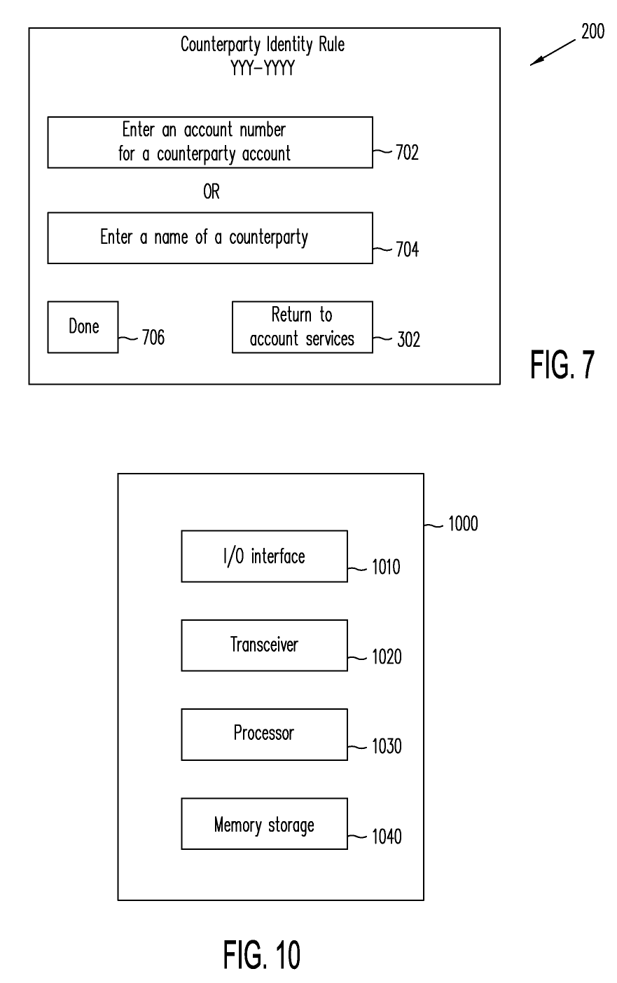

Returning to FIG. 4, the owner may choose option 406 to set up a rule identifying a counterparty. Upon selection of option 406, the service takes the owner to the screen shown in FIG. 7. There are various ways to identify a counterparty, with two of those ways being by identifying an account number associated with the counter party and a name of the counterparty. The owner may use fields 702, 704 to enter an identification of a counterparty and select button 706 to enter the information. However, any appropriate technique for identifying a counterparty is within the scope of embodiments. Upon identification of a counterparty, the proxy account is limited to use with that counterparty only until specified otherwise by the account owner.

In some instances, an account is, by default, limited for use with the first payee or payor counterparty to a transaction employing the proxy payment account. Thus, rather than having to enter counterparty identification information in the screen of FIG. 7, the owner may simply create the proxy payment account and then use the proxy payment account to either send or receive payment to/from a given counterparty, thereby automatically associating the proxy payment account with the identity of the counterparty. Should the owner desire to use the same proxy payment account with a different counterparty the owner may go back to the payment service and use an interface, such as interface 200, to amend the rule to allow additional counterparties.

FIGS. 2-7 are shown as an illustrative example, other embodiments may provide screens to create more than one proxy account, to attach more than one rule to a given proxy account, and to attach a given rule to more than one proxy account. The scope of the disclosure provides for attaching any appropriate rule, or set of rules, to any number of proxy accounts to suit an account owner's purpose.

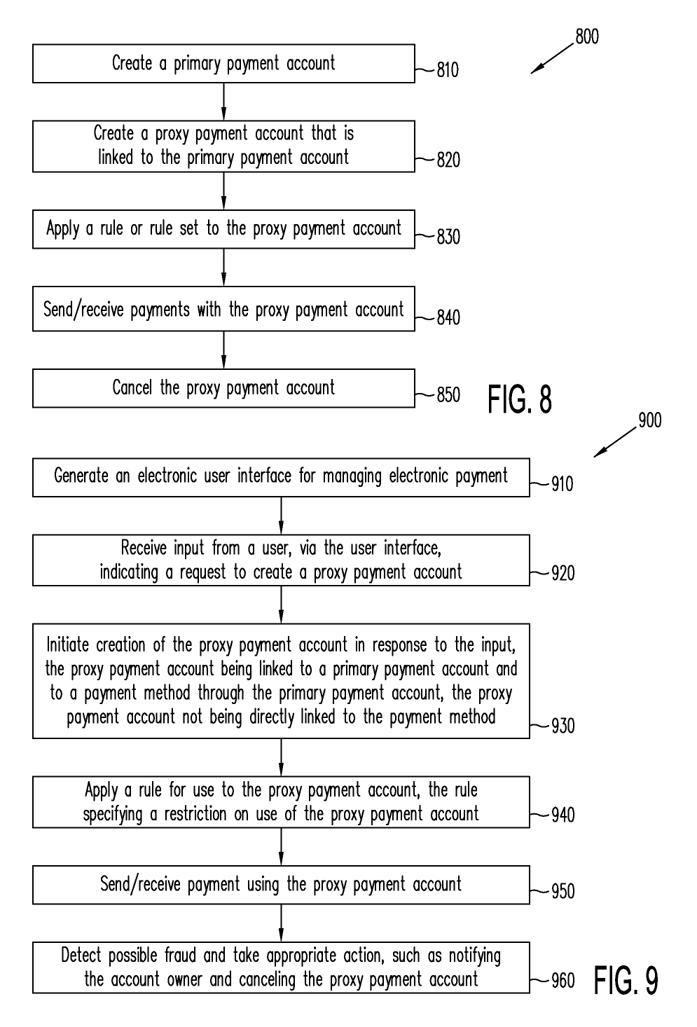

Various embodiments include methods for managing payment using a primary account and a proxy account. FIG. 8 illustrates method 800, adapted according to one embodiment, for a user to manage payment according to the principles discussed above in FIGS. 1-7. In one example, the user employs one or more computers and the interface 200 (FIGS. 2-7) when acting according to method 800.

At block 810, the owner creates a primary payment account. An example primary account is described above at FIG. 1.

At block 820, the owner creates a proxy payment account that is linked to the primary payment account. Example proxy payment accounts are described above at FIG. 1. The owner may create the primary payment account and the proxy payment account in the same web session or application session or a different session. In other words, the scope of embodiments also includes a scenario wherein the owner creates a proxy payment account to link to a primary payment account that has been preexisting for a significant amount of time.

At block 830, the owner applies a rule or rule set to the proxy payment account. An example of applying rules to the proxy payment account is given above at FIGS. 2-7.

At block 840, the owner sends and/or receives payments with the proxy payment account. As explained above, the proxy payment account has different credentials than the primary payment account and is not directly linked to the monies, thereby keeping the primary account and the true method of payment secret from the counterparties interfacing with the proxy payment account. Further, as explained above, the actions of block 840 are carried out consistently with the rule or rule set applied to the proxy payment account. In this example, payment is electronic and accomplished by computers, and thus, the rules are applied automatically by the payment service as the transaction is carried out (or is attempted to be carried out).

In block 850, the owner cancels the proxy payment account. In one example, the owner is notified of possible fraud and cancels the proxy payment account in response thereto. In another example, the owner has set a rule in block 830 to automatically cancel the account after a specified event or time, and the payment service applies the rule automatically absent further instruction by the owner.

The scope of embodiments is not limited to the particular flow shown in FIG. 8. Rather, other embodiments may add, omit, rearrange, or modify one or more actions in accordance with a given design. For instance, the owner may create more than one proxy account and apply any appropriate rules to some or all of the different proxy accounts.

FIG. 9 is an illustration of method 900, adapted according to one embodiment, to manage electronic payment accounts. The actions of FIG. 9 may be performed electronically by a payment service (e.g., a service providing an electronic payment, such as PayPal™, an issuing bank for a credit card or debit card, and/or the like). In some embodiments, the various actions are carried out by one or more computer processors executing computer code to provide the described functionality.

In block 910, the service generates an electronic user interface for managing electronic payment. An example user interface is shown as interface 200 in FIGS. 2-7. The interface allows an owner of a primary payment account to manage the primary account, including to generate one or more proxy payment accounts.

In block 920, the service receives input from a user, via the user interface, indicating a request to create a proxy payment account. The payment service may receive the input over the Internet or other computer network.

In block 930, the payment service initiates creation of the proxy payment account in response to the input. The proxy payment account is linked to the primary payment account and to a payment method through the primary payment account but is not directly linked to the payment method. An example proxy payment account is described above with respect to FIG. 1. Block 930 may further include generating account information, such as an account number, a login, and/or the like.

In block 940, the payment service applies a rule to the proxy payment account. As described above with respect to FIGS. 2-7, the rule sets out a limitation on use of the proxy payment account.

It should be noted that the actions of blocks 910-940 may be carried out in conjunction with a human user at a computer-based device interacting with the interface. In one example, the interface is provided by a website rendered on a web browser or by an application on a personal computer or smartphone. The human user interacts with the payment service, directing the payment service to create the proxy account, create rules, process payments, etc.

In block 950, the payment service facilitates payment processing using the proxy account. In one example, a counterparty presents the proper credentials to send/receive payment using the proxy account. The payment service is aware that the proxy payment account is linked to the primary payment account, and the payment service clears the transaction by depositing or withdrawing an amount of money using the primary payment account. The payment service does not, in this example, provide information to the counterparty indicating the existence of the primary payment account or the specific underlying payment facility.

Block 950 may further include keeping records for the owner that show the transactions totaled at the primary payment account and also booked at the proxy payment account.

Block 960 includes detecting possible fraud. One example of detecting possible fraud includes using conventional fraud detection algorithms currently used by credit card-issuing banks to detect fraud. Another example includes detecting possible fraud anytime there is an attempt to use the proxy payment account inconsistent with any of the rules applied to the proxy payment account. Any technique to detect possible fraud, now known or later developed, may be applied in various embodiments.

Block 960 also includes taking appropriate action. In one example, the payment service notifies the owner of the account of possible fraud and also gives the owner a chance to respond and either confirm that there is no fraud or indicate that there might be fraud. Appropriate action may also include canceling the proxy payment account with or without instruction from the account owner to do so. Any appropriate action is within the scope of embodiments.

The scope of embodiments is not limited to the particular flow shown in FIG. 9. Rather, other embodiments may add, omit, rearrange, or modify one or more actions in accordance with a given design. For instance, method 900 may include creating and managing multiple proxy payment accounts, each with any arbitrary number of rules applied thereto.

Various embodiments may provide one or more advantages over conventional techniques. For instance, the separation between the primary payment account and the proxy payment account, and the lack of knowledge by the counterparty of the primary payment account, provides security to the account owner by limiting the chance that the primary payment account might be compromised. Furthermore, the ability to set rules may prevent unauthorized or fraudulent payment altogether by limiting payment to certain transactions and/or to certain counterparties. At the very least, setting rules for use of the proxy payment account may limit any damage to the primary account by limiting the proxy account to a specific amount of money. An account owner may enjoy both flexibility and security by creating proxy payment accounts and applying appropriate rule sets thereto.

Furthermore, in a scenario wherein one proxy payment account is used per counterparty, canceling and replacing the proxy payment account may include canceling and replacing only a single proxy payment account for one counterparty. Such process may be simpler than replacing account information at a multitude of different counterparties, as is done currently when a credit card is compromised.

FIG. 10 is a simplified block diagram of an example electronic device 1000 on which the account owner may interact with the payment service according to various aspects of the present disclosure. The electronic device 1000 may be a portable personal electronic device, such as a smart phone, laptop, or a tablet. The electronic device 1000 may also be a more powerful computer, for example a server computer. The electronic device 1000 includes an input/output interface 1010. The interface 1010 is operable to receive an input from a user and communicate an output to the user. In an embodiment, the input/output interface 1010 includes a visual display unit, for example a touch-sensitive screen. Input/output interface 101 may display a graphical interface, such as interface 200 of FIGS. 2-7.

The electronic device 1000 includes a transceiver 1020. The transceiver 1020 is operable to electronically communicate with external devices. In an embodiment, the transceiver 1020 is operable to wirelessly communicate with cellular towers or other network access points and infrastructure. The electronic device 1000 also includes a computer processor 1030 that is operable to execute computer instructions and a memory storage 1040 that is operable to store the computer instructions.

The memory storage 1040 also contains a program module that is an embodiment of the application that interacts with the account owner and/or the payment service. The program module operates to provide action such as receiving owner input to create a proxy payment account.

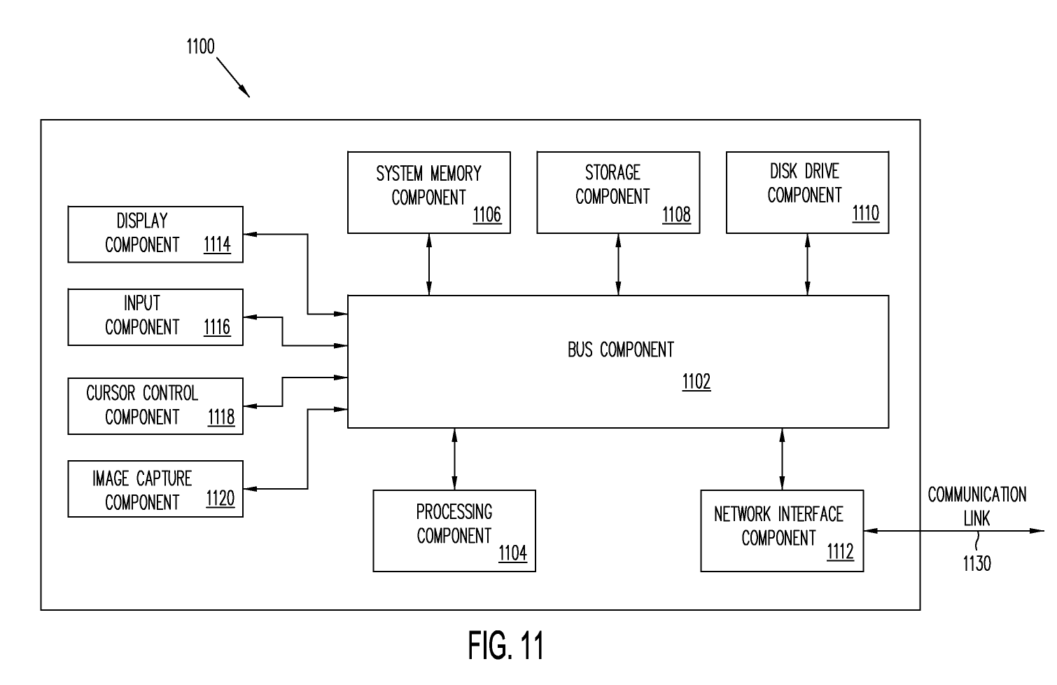

FIG. 11 is a block diagram of a computer system 1100 suitable for implementing various methods and devices described herein, for example, the various method blocks of the method 900. For example, the computer system 1100 may represent a computer upon which the account owner sees interface 200. In another example, the computer system 1100 may represent a server computer or other type of computer that can be used as part of an account management or payment processing infrastructure at a payment service. Accordingly, it should be appreciated that each of the devices may be implemented as the computer system 1100 for communication with a network in a manner as follows.

In accordance with various embodiments of the present disclosure, the computer system 1100, such as a mobile communications device and/or a network server, includes a bus component 1102 or other communication mechanisms for communicating information, which interconnects subsystems and components, such as processing component 1104 (e.g., processor, micro-controller, digital signal processor (DSP), etc.), system memory component 1106 (e.g., RAM), static storage component 1108 (e.g., ROM), disk drive component 1110 (e.g., magnetic or optical), network interface component 1112 (e.g., modem or Ethernet card), display component 1114 (e.g., touch-screens, cathode ray tube (CRT) displays, or liquid crystal display (LCD)), input component 1116 (e.g., keyboard or touch-sensitive components operable to detect a touch by a human body), cursor control component 1118 (e.g., mouse or trackball), and image capture component 1120 (e.g., analog or digital camera). In one implementation, disk drive component 1110 may comprise a database having one or more disk drive components.

In accordance with embodiments of the present disclosure, computer system 1100 performs specific operations by processor 1104 executing one or more sequences of one or more instructions contained in system memory component 1106. Such instructions may be read into system memory component 1106 from another computer readable medium, such as static storage component 1108 or disk drive component 1110. In other embodiments, hard-wired circuitry may be used in place of (or in combination with) software instructions to implement the present disclosure.

Logic may be encoded in a computer readable, non-transitory medium, which may refer to any medium that participates in providing instructions to processor 1104 for execution. Such a medium may take many forms, including but not limited to, non-volatile media and volatile media. In various implementations, non-volatile media includes optical or magnetic disks, such as disk drive component 1110, and volatile media includes dynamic memory, such as system memory component 1106.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 1100. In various other embodiments of the present disclosure, a plurality of computer systems 1100 coupled by communication link 1130 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 1100 may transmit and receive messages, data, information and instructions, including one or more programs (i.e., application code) through communication link 1130 and communication interface 1112. Received program code may be executed by processor 1104 as received and/or stored in disk drive component 1110 or some other storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. A method comprising:
receiving, electronically by a processor of a payment provider, a request to create a proxy payment account from an account owner of a primary payment account, wherein the primary payment account is linked to a method of payment; and
creating, by the processor, the proxy payment account, in which the proxy payment account is linked to the primary payment account but is not linked directly to the method of payment, in which payments to and from the proxy payment account are cleared through the primary payment account;
further in which the primary payment account has first credentials, and in which the proxy payment account has second credentials, the first and second credentials being different.

2. The method of claim 1, further comprising:
associating a rule with the proxy payment account.

3. The method of claim 2, in which the rule comprises a temporal rule including one more of a limit on a lifetime of the proxy payment account and a limit on times at which payments may be made from the proxy payment account.

4. The method of claim 2, in which the rule limits payments to or from the proxy payment account with respect to one or more specified counterparties.

5. The method of claim 2, in which the rule limits an amount of payment to or from the proxy payment account.

6. The method of claim 2, in which the rule limits a number of transactions for which the proxy payment account may be used.

7. The method of claim 2, further comprising:
detecting that a third party has attempted to use the proxy payment account inconsistent with the rule;
notifying the account owner of the detecting; and
cancelling the proxy payment account in response to the detecting.

8. The method of claim 1, further comprising:
automatically deleting the proxy payment account upon determining that the proxy payment account is passed a limit on time or payment amount.

9. The method of claim 1, further comprising:
generating a Graphical User Interface (GUI) for the account owner to create the proxy payment account and to associate one or more rules with the proxy payment account.

10-20. (canceled)

21. The method of claim 9, further comprising:
receiving instructions from a user device via the GUI to apply the one or more rules to use of the proxy payment account; and
applying the one or more rules to the proxy payment account in response to the instructions.

22. A method comprising:
receiving, electronically by a processor of a payment provider, a request to create a proxy payment account from an account owner of a primary payment account, wherein the primary payment account is linked to a method of payment; and
creating, by the processor, the proxy payment account, in which the proxy payment account is linked to the primary payment account but is not linked directly to the method of payment, in which payments to and from the proxy payment account are cleared through the primary payment account;
further in which the primary payment account has first credentials, and in which the proxy payment account has second credentials, the first and second credentials being different, wherein the second credentials are not valid credentials to access the method of payment, and the second credentials access the method of payment through the primary payment account.

23. The method of claim 22, wherein the method of payment comprises at least one of a credit card, a debit card, and a bank account.

24. The method of claim 1, wherein the primary payment account comprises an electronic wallet that is further linked to additional methods of payment.

25. The method of claim 1, further comprising:
receiving the second credentials from a counterparty requesting payment for a transaction; and
making payment for the transaction to the counterparty through the primary payment account without exposing the first credentials.

26-31. (canceled)

32. The method of claim 22, further comprising:
during a transaction, enforcing a rule associated with the proxy payment account.

33. The method of claim 32, wherein enforcing the rule comprises applying one more of a limit on a lifetime of the proxy payment account and a limit on times at which payments may be made from the proxy payment account.

34. The method of claim 32, wherein enforcing the rule comprises limiting payments to or from the proxy payment account with respect to one or more specified counterparties.

34. The method of claim 32, wherein enforcing the rule comprises limiting an amount of payment to or from the proxy payment account.

35. The method of claim 32, wherein enforcing the rule comprises limiting a number of transactions for which the proxy payment account may be used.

36. The method of claim 32, further comprising:
detecting that a third party has attempted to use the proxy payment account inconsistent with the rule;
notifying the account owner of the detecting; and
cancelling the proxy payment account in response to the detecting.
